(19) United States
(12) Patent Application Publication
(10) Pub. No.: US 2025/0206320 A1
(43) Pub. Date: Jun. 26, 2025

(54) Estimating a Motion State of a Vehicle from Camera Data by Means of Machine Learning

(71) Applicant: Robert Bosch GmbH, Stuttgart (DE)

(72) Inventor: Simon Weissenmayer, Flein (DE)

(21) Appl. No.: 18/727,200

(22) PCT Filed: Jan. 10, 2023
(86) PCT No.: PCT/EP2023/050391

§ 371 Date: Jan. 6, 2025

(30) Foreign Application Priority Data
Jan. 10, 2022 (DE) 10 2022 200 142.7

(51) Int. Cl. B60W 40/105; G06V 10/82; G06V 20/56

(52) U.S. Cl. CPC B60W 40/105; G06V 10/82; G06V 20/56

(57) ABSTRACT

A method is for estimating a motion state of a vehicle, which is equipped with a camera for sensing a surroundings of the vehicle. The method includes receiving camera data that has been generated by the camera and inputting the camera data into an algorithm in order to convert the camera data into motion data that describe a current motion state of the vehicle. The algorithm has been trained with historical camera data and with reference motion data associated with the historical camera data. The method further includes determining an estimated motion state of the vehicle from the motion data using a state estimator.

### FIELD OF THE INVENTION

The invention relates to a method for estimating a motion state of a vehicle. The invention also relates to a controller and a computer program for carrying out such a method, and to a computer-readable medium on which such a computer program is stored.

### PRIOR ART

Measurement data from inexpensive inertial sensors, which are used to sense a motion state of a vehicle, often contains measurement errors which can increase as a result of temperature changes. To keep the measurement errors small, the measurement data can be corrected using a so-called strapdown calculation, for example. Over a relatively long period of time, integration errors can occur in this process, and these integration errors can lead to inaccuracies in determining velocity values or rotation angle values. For this reason, position data from a global navigation satellite system and/or measurement data from one or more wheel speed sensors is often additionally used, in order to correct the results of the strapdown calculation. The correction can occur, for example, in a Kalman filter.

### DISCLOSURE OF THE INVENTION

Against this background, a method for estimating a motion state of a vehicle, a corresponding controller, a corresponding computer program, and a corresponding computer-readable medium according to the independent claims are presented below. Advantageous further developments and improvements of the approach presented here will emerge from the description and are described in the dependent claims.

### Advantages of the Invention

Embodiments of the present invention allow for a highly accurate estimation of a motion state of a vehicle on the basis of camera data, without necessarily requiring, for this purpose, sensor data from additional sensor equipment, such as an inertial sensor or a satellite-based location sensor.

A first aspect of the invention relates to a computer-implemented method for estimating a motion state of a vehicle equipped with one or more cameras for capturing a surroundings of the vehicle. The method comprises at least the following steps: (i) receiving camera data that has been generated by the camera; (ii) inputting the camera data into an algorithm, which has been trained with historical camera data and with reference motion data associated with the historical camera data, in order to convert the camera data into motion data that describes a current motion state of the vehicle; and (iii) determining an estimated motion state of the vehicle from the motion data by means of a state estimator.

For example, the camera data can be received in step (i) in a plurality of successive time steps, wherein steps (ii) to (iii) are performed in each time step. For example, in a current time step the motion data can be input into the state estimator to obtain, in the current time step, estimation data describing the estimated motion state of the vehicle at a time step subsequent to the current time step. The estimation data can comprise, for example, values of an estimated velocity and/or an estimated rotation angle of the vehicle with respect to one or more spatial axes.

For example, the state estimator can be a Kalman filter, a variant of a Kalman filter, a particle filter, or a combination of at least two of these examples.

The term “algorithm” can be understood to mean a classification algorithm and/or regression algorithm that has been configured by means of a machine learning method to assign to a specific image captured by a camera, i.e. a two-dimensional or multi-dimensional matrix of specific color values and/or brightness values, and/or to a sequence of at least two such images, one or more estimation values for at least one motion variable that is suitable for characterizing the current motion state of the vehicle. A suitable motion variable can be, for example, an acceleration, rotation rate, velocity, or rotation angle. The motion variables can each be related to one, two or three different spatial axes of a coordinate system in which the vehicle is moving and/or which moves with the vehicle.

The historical camera data can have been provided by one or more real cameras, for example by the camera of the vehicle and/or at least one other camera of at least one other vehicle. However, the historical camera data can also be from a simulation of the camera, of the vehicle and/or of the surroundings of the vehicle. The reference motion data can comprise, for example, velocity values, acceleration values, rotation angle values, and/or rotation rate values, which can be associated with images in the historical camera data.

The method can, for example, be carried out automatically by a processor of a controller of the vehicle. The controller can be additionally configured to perform a satellite-based navigation function and/or one or more driver assistance functions, such as ABS or ESC, that can be used to steer, accelerate and/or brake the vehicle according to the estimated motion state. For this purpose, the vehicle can comprise corresponding actuator equipment, for example in the form of a steering actuator, a brake actuator, an engine control unit, an electric drive motor, or a combination of at least two of these examples.

The vehicle can be a motor vehicle, such as a passenger car, truck, bus, or motorcycle. The vehicle can be guided by a human or can be moved fully or partially autonomously. In a broader sense, the term “vehicle” can also be understood to mean an aircraft, a ship, a crane, or an autonomous, mobile robot. For example, the method described above and in the following can be used to estimate the motion state of a hook of the crane.

The camera can be installed, for example, in a front, rear and/or side region of the (motor) vehicle. Alternatively, the camera can be a component of a smartphone or smartwatch.

A second aspect of the invention relates to a controller comprising a processor configured to carry out the method described above and in the following. The controller can comprise hardware and/or software modules. In addition to the processor, the controller can comprise a storage means and data communication interfaces for data communication with peripheral devices. Features of the method can also be considered features of the controller and vice versa.

Further aspects of the invention relate to a computer program and a computer-readable medium on which the computer program is stored.

The computer program comprises instructions that, when the computer program is executed by a processor, cause said processor to carry out the method described above and in the following.

The computer-readable medium can be a volatile or non-volatile data storage means. The computer-readable medium can be a hard drive, a USB memory device, a RAM, a ROM, an EPROM, or a flash memory, for example. The computer-readable medium can also be a data communication network allowing a program code to be downloaded, such as the Internet or a data cloud.

Features of the method described above and in the following can also be considered features of the computer program and/or of the computer-readable medium, and vice versa.

Possible features and advantages of embodiments of the invention can be regarded as being based, among other things, and without limiting the invention, on the ideas and insights described in the following.

According to one embodiment, the motion data can indicate a current velocity, a current acceleration, a current rotation angle, and/or a current rotation rate of the vehicle. Additionally or alternatively, the state estimator can determine an estimated velocity and/or an estimated rotation angle of the vehicle. As already mentioned, the camera data can comprise color values and/or brightness values that can be converted by the algorithm into estimation values of the aforementioned motion variables.

According to one embodiment, the motion data can additionally indicate variances with respect to the current motion state. Additionally or alternatively, the state estimator can additionally determine variances with respect to the estimated motion state. For example, the motion data can comprise current values for one or more motion variables, wherein each current value is assigned a corresponding variance value and/or at least one other statistical value that quantifies an uncertainty regarding the respective value. These variances can be evaluated by the state estimator in order to determine the estimated motion state even more accurately. In so doing, the state estimator can determine estimated variances, which can be considered in the determination of the estimated motion state and/or be output by the state estimator for external further processing.

According to one embodiment, the state estimator can be a Kalman filter. The term “Kalman filter” can also be understood to mean a variant of a Kalman filter, such as an extended Kalman filter or an unscented Kalman filter, or a combination of at least two such variants. The estimated motion state can thereby be determined particularly efficiently.

According to one embodiment, the algorithm can be an artificial neural network. The artificial neural network can comprise, for example, a multi-layer perceptron, a convolutional neural network, and/or an LSTM (long short-term memory) architecture. The current motion state of the vehicle can thereby be determined very accurately. In particular, the determination can be made more accurately than would be the case with common inertial sensors. For example, it is thereby possible to avoid inaccuracies due to measurement errors typical of inertial sensors. The estimated motion state of the vehicle can be determined correspondingly more accurately by the state estimator.

According to one embodiment, to train the algorithm a cost function that quantifies a deviation between the motion data and the reference motion data can have been minimized. The cost function can be a likelihood function, in particular a log likelihood function. In other words, the algorithm can have been optimized taking into account uncertainties regarding the input and/or output data of the algorithm and/or regarding the reference motion data with which the output data is compared. For example, the algorithm can have been optimized in a gradient method by back propagation. However, an optimization using normal equations is also possible. The method can thereby be further improved.

According to one embodiment, the reference motion data can have been generated by an inertial sensor, a satellite-based location sensor, and/or a wheel speed sensor. For example, the reference motion data can have been provided by a particularly high-quality and correspondingly accurate inertial sensor, which is typically not installed in a vehicle for cost reasons. In other words, the motion state of the vehicle can be estimated with an accuracy at least as high as when the motion data is provided by such a high-quality inertial sensor, but without the inertial sensor actually needing to be installed in the vehicle.

According to one embodiment, sensor data that has been generated by additional sensor equipment of the vehicle can additionally be received and be input into the state estimator. In this way, the accuracy of the method can be increased. Moreover, the fail-safety of the system can thereby be increased. For example, the estimated motion state can still be determined even if the camera fails or is impaired in function.

According to one embodiment, the additional sensor equipment can comprise at least one inertial sensor, one satellite-based location sensor, and/or one wheel speed sensor. In this case, significantly more cost-effective sensor equipment can be used to provide the sensor data than when the estimated motion state is determined solely from the sensor data, i.e. without the motion data that is obtained from the camera data. In addition, this allows for prognosis and correction of the sensor data on the basis of the camera data. For example, errors in the output data of an inertial sensor can thus be reliably detected.

### BRIEF DESCRIPTION OF THE DRAWINGS

Embodiments of the invention are described in the following with reference to the accompanying drawings, wherein neither the drawings nor the description are to be construed as limiting the invention.

FIG. 1 shows a vehicle having a vehicle system, which comprises a camera and a controller according to an embodiment of the invention.

FIG. 2 shows the vehicle system of FIG. 1 in detail.

FIG. 3 illustrates an algorithm in the form of an artificial neural network for use in a method according to an embodiment of the invention.

The figures are merely schematic and are not to scale. Identical reference signs in the figures denote identical or functionally identical features.

### EMBODIMENTS OF THE INVENTION

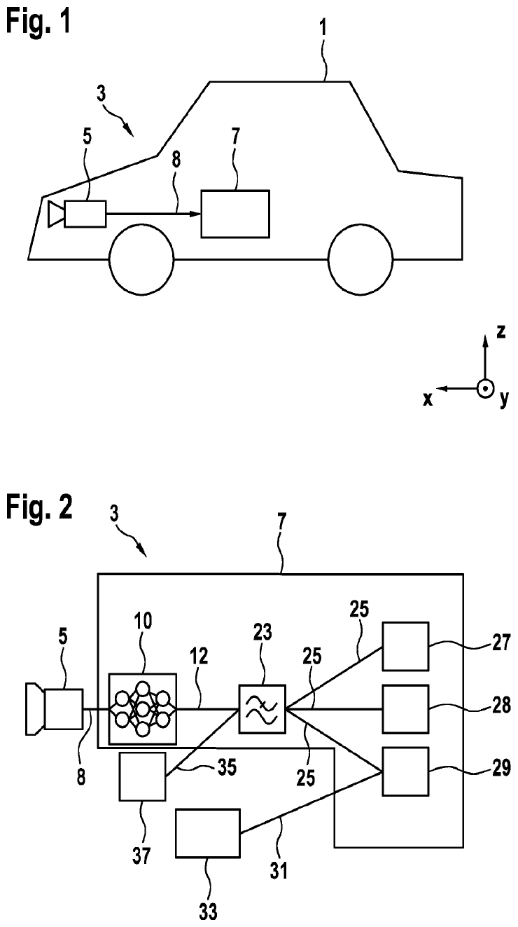

FIG. 1 shows a vehicle 1 equipped with a vehicle system 3 consisting of a camera 5 for sensing a surroundings of the vehicle 1 and a controller 7 for evaluating camera data 8 from the camera 5 in a method described in the following.

FIG. 2 shows possible components of the vehicle system 3 or of the controller 7.

In this example, the controller 7 comprises a machine learning algorithm 10, hereinafter abbreviated as algorithm 10, which has been trained with historical camera data and with reference motion data to convert the camera data 8 into motion data 12 comprising values of one or more motion variables. Accordingly, the reference motion data can comprise reference values for these one or more motion variables that can be temporally correlated with the historical camera data in a suitable manner.

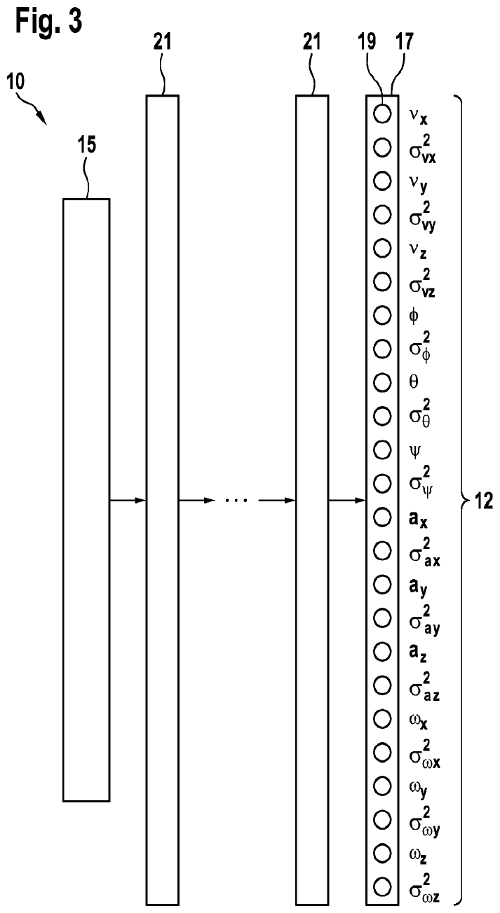

The algorithm 10 is, by way of example, embodied here as an artificial neural network, the principal structure of which is shown in FIG. 3. The network comprises an input layer 15 into which the camera data 8 is input and an output layer 17 having a plurality of output neurons 19 which output the motion data 12, here values of a longitudinal velocity vₓ, a lateral velocity v_{y}, a vertical velocity v_{z}, a longitudinal acceleration aₓ, a lateral acceleration a_{y}, a vertical acceleration a_{z}, a roll angle ϕ, a pitch angle θ, a yaw angle ψ, a roll rate ωₓ, a pitch rate ω_{y}, and a yaw rate ω_{z}. The input layer 15 and the output layer 17 are connected to one another by a plurality of intermediate layers 21, which lie one behind the other and each of which can comprise a plurality of neurons with trainable weights, wherein the outputs of an intermediate layer 21 are inputs into the respective subsequent intermediate layer 21.

Additionally, for each of the aforementioned motion variables the algorithm 10 can output uncertainties, for example in the form of corresponding variances σᵥₓ², σ_{vy}², σₐₓ², σ_{ay}², σ_{az}², σ_{ϕ}², σ_{θ}², σ_{ψ}², σ_{ωx}², σ_{ωy}², σ_{ωz}².

In addition a state estimator 23, for example a Kalman filter, runs on the controller 7, which state estimator receives the motion data 12 from the algorithm 10 in each time step and generates estimation data 25 therefrom describing an estimated motion state of the vehicle 1 at a future time subsequent to the particular time. The estimation data 25 can be provided, for example, to an ABS module 27, an ESC module 28, and/or a navigation module 29 for satellite-based navigation of the vehicle 1 on the basis of sensor data 31 from a corresponding location sensor 33.

In this example, sensor data 35 from an inertial sensor 37 of the vehicle 1 is additionally input into the state estimator 23. The sensor data 35 and the camera data 12 can be temporally correlated with each other in a suitable manner.

The calculation of the estimation data 25 is explained in more detail in the following.

First, the algorithm 10 calculates, from the camera data 8, first model values z=[v_{x,k} v_{y,k} v_{z,k} ϕₖ θₖ ψₖ]^{T}, comprising first velocity values [v_{x,k} v_{y,k} v_{z,k}]^{T} and first roll, pitch and yaw angle values [ϕₖ θₖ ψₖ]^{T}.

In addition, the algorithm 10 calculates, from the camera data 8, the first further model values u=[a_{x,k} a_{y,k} a_{z,k} ω_{x,k} ω_{y,k} ω_{z,k}]^{T}, comprising acceleration values [a_{x,k} a_{y,k} a_{z,k}] and angle change values [ω_{x,k} ω_{y,k} ω_{z,k}]^{T}.

Using a strapdown calculation or Kalman filter calculation, it is possible to calculate, from the first further model values u and from the second model values \hat{x}=[\hat{v}_{x,k} \hat{v}_{y,k} \hat{v}_{z,k} \hat{ϕ}ₖ \hat{θ}ₖ \hat{ψ}ₖ]^{T}, comprising second roll, pitch and yaw angle values [\hat{ϕ}ₖ \hat{θ}ₖ \hat{ψ}ₖ]^{T}, the second model values \hat{x}ₖ₊₁=[\hat{v}_{x,k+1} \hat{v}_{y,k+1} \hat{v}_{z,k+1} \hat{ϕ}ₖ₊₁ \hat{θ}ₖ₊₁ \hat{ψ}ₖ₊₁]^{T} of the subsequent time step k+1, comprising second velocity values [\hat{v}_{x,k+1} \hat{v}_{y,k+1} \hat{v}_{z,k+11}]^{T} and second roll, pitch and yaw angle values [\hat{ϕ}ₖ₊₁ \hat{θ}ₖ₊₁ ψₖ₊₁]^{T}, by discrete integration over time dt:

$$( 1 )$$

$$[ \begin{matrix}{\hat{v}}_{x , k + 1} \\ {\hat{v}}_{y , k + 1} \\ {\hat{v}}_{z , k + 1}\end{matrix} ] = [ \begin{matrix}{\hat{v}}_{x , k} \\ {\hat{v}}_{y , k} \\ {\hat{v}}_{z , k}\end{matrix} ] + dt ( [ \begin{matrix}{a}_{x , k} \\ {a}_{y , k} \\ {a}_{z , k}\end{matrix} ] - {\underbrace{[ \begin{matrix}{ω}_{x , k} \\ {ω}_{y , k} \\ {ω}_{z , k}\end{matrix} ] \times [ \begin{matrix}{\hat{v}}_{x , k} \\ {\hat{v}}_{y , k} \\ {\hat{v}}_{z , k}\end{matrix} ]}}_{Centrifugal Acceleration} {\underbrace{- g [ \begin{matrix}- sin ( {\hat{θ}}_{k} ) \\ cos ( {\hat{θ}}_{k} ) \cdot sin ( {\hat{ϕ}}_{k} ) \\ cos ( {\hat{θ}}_{k} ) \cdot cos ( {\hat{ϕ}}_{k} )\end{matrix} ]}}_{Acceleration due to gravity} )$$

$$[ \begin{matrix}{\hat{ϕ}}_{k + 1} \\ {\hat{θ}}_{k + 1} \\ {\hat{ψ}}_{k + 1}\end{matrix} ] = [ \begin{matrix}{\hat{ϕ}}_{k} \\ {\hat{θ}}_{k} \\ {\hat{ψ}}_{k}\end{matrix} ] + dt [ \begin{matrix}1 & sin ( {\hat{ϕ}}_{k} ) \cdot tan ( {\hat{θ}}_{k} ) & cos ( {\hat{ϕ}}_{k} ) \cdot tan ( {\hat{θ}}_{k} ) \\ 0 & cos ( {\hat{ϕ}}_{k} ) & - sin ( {\hat{ϕ}}_{k} ) \\ 0 & \frac{sin ( {\hat{ϕ}}_{k} )}{cos ( {\hat{θ}}_{k} )} & \frac{cos ( {\hat{ϕ}}_{k} )}{cos ( {\hat{θ}}_{k} )}\end{matrix} ] \cdot [ \begin{matrix}{ω}_{x , k} \\ {ω}_{y , k} \\ {ω}_{z , k}\end{matrix} ] \qquad ( 2 )$$

The first model values can be used to correct the second model values. The correction can be made using a Kalman filter.

For the training of the algorithm 10, data from an inertial sensor 37, such as angular velocities, accelerations and optionally an inclination angle, and additionally data from a satellite navigation system 33, such as velocities and optionally an inclination angle, can be used as reference. The algorithm 10 can then output the first model values and the first further model values. Moreover, it is particularly advantageous if the algorithm 10, as shown in FIG. 3, outputs, in addition to each first model value and each first further model value, an associated first confidence value and an associated first further confidence value, respectively, such as a variance σ². Each output μϵ{u,z}={vₓ, v_{y}, . . . ω_{z}} is then associated with an additional variance output σ²ϵ{σᵥₓ², σ_{vy}², σ_{ωz}²}.

The algorithm 10 can be trained using the respective outputs μₖϵ{v_{x,k}, v_{y,k}, . . . ω_{z,k}} and σₖ²ϵ{σ_{vx,k}², σ_{vy,k}², . . . σ_{ωz,k}²} and the associated reference values μ_{ref,k}ϵ{v_{x,ref,k} v_{y,ref,k}, . . . ω_{z,ref,k}} and σ_{ref,k}²ϵ{σ_{vx,ref,k}², σ_{vy,ref,k}², . . . σ_{ωz,ref,k}²} in such a way that the double negative log likelihood function

$$- 2 ln ( L ) = {\sum }_{k}^{n} ( ln ( 2 π ( {σ}_{k}^{2} + {σ}_{ref , k}^{2} ) ) + \frac{{( {μ}_{k} - {μ}_{ref , k} )}^{2}}{{σ}_{k}^{2} + {σ}_{ref , k}^{2}} ) \qquad ( 3 )$$

is minimized over a total of n calculation steps k.

Layers with recurrent calculations such as GRU (gated recurrent unit) or LSTM, convolutional layers, and in particular layers with stochastic neurons can be used in the artificial neural network of the algorithm 10.

The variance outputs of algorithm 10 can be used to perform the correction of the second model values particularly well using the first model values. In addition to the second model values, associated second confidence values \hat{σ}ₖ₊₁²ϵ{\hat{σ}_{vx,k+1}², \hat{σ}_{vy,k+1}², . . . , \hat{σ}_{ψ,k+1}²} can also be calculated.

To calculate the associated second confidence values \hat{σ}ₖ₊₁², the model

$$\dot{\hat{x}} = f ( \hat{x} , u ) = [ \begin{matrix}{a}_{x} - {ω}_{y} {\hat{v}}_{z} + {ω}_{z} {\hat{v}}_{y} + g sin ( \hat{θ} ) \\ {a}_{y} + {ω}_{x} {\hat{v}}_{z} - {ω}_{z} {\hat{v}}_{x} - g cos ( \hat{θ} ) sin ( \hat{ϕ} ) \\ {a}_{z} + {ω}_{x} {\hat{v}}_{y} + {ω}_{y} {\hat{v}}_{x} - g cos ( \hat{θ} ) cos ( \hat{ϕ} ) \\ {ω}_{x} + {ω}_{y} sin ( \hat{ϕ} ) tan ( \hat{θ} ) + {ω}_{z} cos ( \hat{ϕ} ) tan ( \hat{θ} ) \\ {ω}_{y} cos ( \hat{ϕ} ) - {ω}_{z} sin ( \hat{ϕ} ) \\ \frac{{ω}_{z} sin ( \hat{ϕ} )}{cos ( \hat{θ} )} + \frac{{ω}_{z} cos ( \hat{ϕ} )}{cos ( \hat{θ} )}\end{matrix} ] \qquad ( 4 )$$

can be linearized with the second model values \hat{x}=[\hat{v}ₓ \hat{v}_{y} \hat{v}_{z} \hat{ϕ}ₖ \hat{θ}ₖ \hat{ψ}ₖ]^{T} and the first further model values u=[aₓ a_{y} a_{z} ωₓ ω_{y} ω_{z}]^{T} to form

$$\dot{\hat{x}} = f ( \hat{x} , u ) = \frac{\partial f ( \hat{x} , u )}{\partial \hat{x}} \hat{x} + \frac{\partial f ( \hat{x} , u )}{\partial u} u \qquad ( 5 )$$

$$with \qquad ( 6 )$$

$$\frac{\partial f ( \hat{x} , u )}{\partial \hat{x}} = [ \text{} \begin{matrix}0 & {ω}_{z} & - {ω}_{y} & 0 & g cos ( \hat{θ} ) & 0 \\ - {ω}_{z} & 0 & {ω}_{x} & - g cos ( \hat{θ} ) cos ( \hat{ϕ} ) & g sin ( \hat{θ} ) sin ( \hat{ϕ} ) & 0 \\ {ω}_{y} & - {ω}_{x} & 0 & g cos ( \hat{θ} ) sin ( \hat{ϕ} ) & g sin ( \hat{θ} ) cos ( \hat{ϕ} ) & 0 \\ 0 & 0 & 0 & \begin{matrix}( {ω}_{y} cos ( \hat{ϕ} ) - \\ {ω}_{z} sin ( \hat{ϕ} ) ) tan ( \hat{θ} )\end{matrix} & \begin{matrix}( {ω}_{y} sin ( \hat{ϕ} ) + \\ ( {ω}_{z} cos ( \hat{ϕ} ) ) ( 1 + {tan}^{2} ( \hat{θ} ) )\end{matrix} & 0 \\ 0 & 0 & 0 & - {ω}_{y} sin ( \hat{ϕ} ) - {ω}_{z} cos ( \hat{ϕ} ) & 0 & 0 \\ 0 & 0 & 0 & \frac{{ω}_{y} cos ( \hat{ϕ} )}{cos ( \hat{θ} )} - \frac{{ω}_{z} sin ( \hat{ϕ} )}{cos ( \hat{θ} )} & \begin{matrix}\frac{{ω}_{z} cos ( \hat{ϕ} ) sin ( \hat{θ} )}{{cos ( \hat{θ} )}^{2}} + \\ \frac{{ω}_{y} sin ( \hat{ϕ} ) sin ( \hat{θ} )}{{cos ( \hat{θ} )}^{2}}\end{matrix} & 0\end{matrix} ]$$

$$and$$

$$\frac{\partial f ( \hat{x} , u )}{\partial u} = [ \begin{matrix}1 & 0 & 0 & 0 & - {v}_{z} & {v}_{y} \\ 0 & 1 & 0 & {v}_{z} & 0 & - {v}_{x} \\ 0 & 0 & 1 & - {v}_{y} & {v}_{x} & 0 \\ 0 & 0 & 0 & 1 & sin ( \hat{ϕ} ) tan ( \hat{θ} ) & cos ( \hat{ϕ} ) tan ( \hat{θ} ) \\ 0 & 0 & 0 & 0 & cos ( \hat{ϕ} ) & - sin ( \hat{ϕ} ) \\ 0 & 0 & 0 & 0 & \frac{sin ( \hat{ϕ} )}{cos ( \hat{θ} )} & \frac{cos ( \hat{ϕ} )}{cos ( \hat{θ} )}\end{matrix} ] \qquad ( 7 )$$

The linearized strapdown model can be used to predict the Kalman filter states or the second model values

$${\hat{x}}_{k + 1} = {\hat{x}}_{k} + dt \dot{\hat{x}} = {\underbrace{( I + dt \frac{\partial f ( \hat{x} , u )}{\partial \hat{x}} )}}_{A} {\hat{x}}_{k} + {\underbrace{dt \frac{\partial f ( \hat{x} , u )}{\partial u}}}_{B} u \qquad ( 6 )$$

and to predict the Kalman filter covariance matrix

$${\hat{P}}_{k + 1} = A {\hat{P}}_{k} A + BQB \qquad ( 7 )$$

$$with$$

$$Q = [ \begin{matrix}{σ}_{ax}^{2} & 0 & 0 & 0 & 0 & 0 \\ 0 & {σ}_{ay}^{2} & 0 & 0 & 0 & 0 \\ 0 & 0 & {σ}_{az}^{2} & 0 & 0 & 0 \\ 0 & 0 & 0 & {σ}_{ω x}^{2} & 0 & 0 \\ 0 & 0 & 0 & 0 & {σ}_{ω y}^{2} & 0 \\ 0 & 0 & 0 & 0 & 0 & {σ}_{ω z}^{2}\end{matrix} ] \qquad ( 8 )$$

$$and$$

$$\hat{P} = [ \begin{matrix}{\hat{σ}}_{vx}^{2} & {\hat{σ}}_{vx} {\hat{σ}}_{vy} & {\hat{σ}}_{vx} {\hat{σ}}_{vz} & {\hat{σ}}_{vx} {\hat{σ}}_{ϕ} & {\hat{σ}}_{vx} {\hat{σ}}_{θ} & {\hat{σ}}_{vx} {\hat{σ}}_{ψ} \\ {\hat{σ}}_{vx} {\hat{σ}}_{vy} & {\hat{σ}}_{vy}^{2} & {\hat{σ}}_{vy} {\hat{σ}}_{vz} & {\hat{σ}}_{vy} {\hat{σ}}_{ϕ} & {\hat{σ}}_{vy} {\hat{σ}}_{θ} & {\hat{σ}}_{vy} {\hat{σ}}_{ψ} \\ {\hat{σ}}_{vx} {\hat{σ}}_{vz} & {\hat{σ}}_{vy} {\hat{σ}}_{vz} & {\hat{σ}}_{vz}^{2} & {\hat{σ}}_{vz} {\hat{σ}}_{ϕ} & {\hat{σ}}_{vz} {\hat{σ}}_{θ} & {\hat{σ}}_{vz} {\hat{σ}}_{ψ} \\ {\hat{σ}}_{vx} {\hat{σ}}_{ϕ} & {\hat{σ}}_{vy} {\hat{σ}}_{ϕ} & {\hat{σ}}_{vz} {\hat{σ}}_{ϕ} & {\hat{σ}}_{ϕ}^{2} & {\hat{σ}}_{ϕ} {\hat{σ}}_{θ} & {\hat{σ}}_{ϕ} {\hat{σ}}_{ψ} \\ {\hat{σ}}_{vx} {\hat{σ}}_{θ} & {\hat{σ}}_{vy} {\hat{σ}}_{θ} & {\hat{σ}}_{vz} {\hat{σ}}_{θ} & {\hat{σ}}_{ϕ} {\hat{σ}}_{θ} & {\hat{σ}}_{θ}^{2} & {\hat{σ}}_{ϕ} {\hat{σ}}_{ψ} \\ {\hat{σ}}_{vx} {\hat{σ}}_{ψ} & {\hat{σ}}_{vy} {\hat{σ}}_{ψ} & {\hat{σ}}_{vz} {\hat{σ}}_{ψ} & {\hat{σ}}_{ϕ} {\hat{σ}}_{ψ} & {\hat{σ}}_{θ} {\hat{σ}}_{ψ} & {\hat{σ}}_{ψ}^{2}\end{matrix} ] \qquad ( 9 )$$

wherein additionally the resulting covariances \hat{σ}ᵥₓ\hat{σ}_{vy} . . . \hat{σ}ᵥₓ\hat{σ}_{ψ} . . . \hat{σ}_{θ}\hat{σ}_{ψ} on the broken diagonals of the covariance matrix \hat{P} can also be predicted.

The correction of the second model values \hat{x}=[\hat{v}_{x,k} \hat{v}_{y,k} \hat{v}_{z,k} \hat{ϕ}ₖ \hat{θ}ₖ \hat{ψ}ₖ]^{T} by means of the first model values z=[v_{x,k} v_{y,k} v_{z,k} ϕₖ θₖ ψₖ]^{T} can be performed in the Kalman filter using the Kalman gain

$$K = \hat{P} {{H}^{T} ( H \hat{P} {H}^{T} + R )}^{- 1} \qquad ( 10 )$$

$$with {H}^{T} = I and$$

$$R = [ \begin{matrix}{σ}_{vx}^{2} & 0 & 0 & 0 & 0 & 0 \\ 0 & {σ}_{vy}^{2} & 0 & 0 & 0 & 0 \\ 0 & 0 & {σ}_{vz}^{2} & 0 & 0 & 0 \\ 0 & 0 & 0 & {σ}_{ϕ}^{2} & 0 & 0 \\ 0 & 0 & 0 & 0 & {σ}_{θ}^{2} & 0 \\ 0 & 0 & 0 & 0 & 0 & {σ}_{ψ}^{2}\end{matrix} ] \qquad ( 11 )$$

as follows:

$${\hat{x}}^{′} = \hat{x} + K ( z - H \hat{x} ) \qquad ( 12 )$$

The covariance matrix \hat{P} can also be corrected as follows:

$${\hat{P}}^{′} = ( I - KH ) \hat{P} \qquad ( 13 )$$

Lastly, it should be noted that terms such as “having”, “comprising”, etc. do not exclude other elements or steps and indefinite articles such as “a” or “an” do not exclude a plurality. Reference signs in the claims should not be construed as limitations.

1. A method for estimating a motion state of a vehicle, wherein the vehicle is equipped with a camera for sensing a surroundings of the vehicle, the method comprising:
receiving camera data that have been generated by the camera;
inputting the camera data into an algorithm to convert the camera data into motion data that describe a current motion state of the vehicle, the algorithm having been trained with historical camera data and with reference motion data associated with the historical camera data; and
determining an estimated motion state of the vehicle from the motion data using a state estimator.

2. The method according to claim 1, wherein:
the motion data indicate a current velocity, a current acceleration, a current rotation angle, and/or a current rotation rate of the vehicle; and/or
the state estimator determines an estimated velocity and/or an estimated rotation angle of the vehicle.

3. The method according to claim 1, wherein:
the motion data additionally indicate variances with respect to the current motion state; and/or
the state estimator additionally determines variances with respect to the estimated motion state.

4. The method according to claim 1, wherein the state estimator is a Kalman filter.

5. The method according to claim 1, wherein the algorithm is an artificial neural network.

6. The method according to claim 1, wherein:
to train the algorithm, a cost function that quantifies a deviation between the motion data and the reference motion data has been minimized, and
the cost function is a log likelihood function.

7. The method according to claim 1, wherein the reference motion data has been generated by an inertial sensor and/or a satellite-based location sensor.

8. The method according to claim 1, wherein:
additional sensor data that have been generated by additional sensor equipment of the vehicle are received and are input into the state estimator, and
the state estimator determines the estimated motion state additionally from the additional sensor data.

9. The method according to claim 8, wherein the additional sensor equipment comprises at least one inertial sensor, one satellite-based location sensor, and/or one wheel speed sensor.

10. A controller comprising:
a processor configured to carry out the method according to claim 1.

11. The method according to claim 1, wherein a computer program comprises instructions that, when the computer program is executed by a processor, cause the processor to carry out the method.

12. A non-transitory computer-readable medium on which the computer program according to claim 11 is stored.
